(19) United States
(12) Patent Application Publication
(10) Pub. No.: US 2009/0016313 A1
(43) Pub. Date: Jan. 15, 2009

(54) METHOD AND APPARATUS FOR SWITCHING A COMMUNICATION CHANNEL

(76) Inventor: Weihua Wu, Beijing (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/777,753

(22) Filed: Jul. 13, 2007

(51) Int. Cl. H04B 7/212; H04B 7/00; H04J 3/00; H04Q 7/24

(52) U.S. Cl. 370/345; 370/338; 370/347; 455/524

(57) ABSTRACT

Method and apparatus for switching a communication channel is described. In some embodiments, a station may suspend communicating directly with another station on a first communication channel without passing communication packets through an access point, in response to a decision of communicating directly with the another station on a second communication channel. Then, the station may switch from the first communication channel to the second communication channel and resume communicating directly with the another station on the second communication channel. When communicating on the second communication channel, the station may pretend to be in an inactive mode in respect to the access point.

### BACKGROUND

Basic service set (BSS) may be a basic building block of a wireless local area network (WLAN). A BSS may comprise one or more stations and an access point. The access point may act as a master to control the station(s) within the BSS. According to a direct link protocol, a direct link may be established between two stations of a BSS so that the two stations may communicate directly with each other on the direct link, rather than passing communication packets via the access point. One channel may be used for all communications within the BSS.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a basic service set.

FIG. 2 shows an embodiment of an implementation of communication channel switch between two stations in the basic service set.

FIG. 3 shows an embodiment of a method of switching a communication channel.

FIG. 4 shows an embodiment of a station.

### DETAILED DESCRIPTION

The following description describes method and apparatus for switching a communication channel. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or sending information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

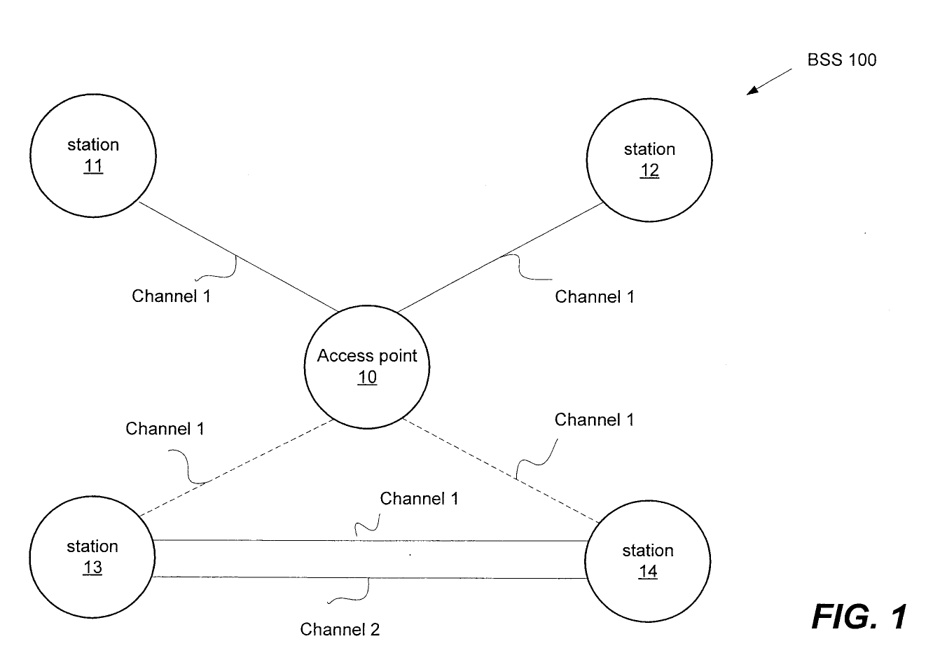

FIG. 1 shows an embodiment of a basic service set (BSS) 100 on a communication network, for example, a wireless local area network. Two stations within the BSS (e.g., stations 11 and 12) may communication with each other on a channel (e.g., channel 1), by passing communication packets through the access point 10 (i.e., communicate with each other indirectly). Alternatively, two stations within the BSS (e.g., station 13 and 14) may communicate with each other on the same channel (e.g., channel 1) without passing communication packets through the access point 10 (i.e., communicate with each other directly), and meanwhile, one or both of them may communicate indirectly with other stations within the BSS on the same channel. For the later case, the two stations may communicate directly with each other based upon a direct link protocol. Each station within the BSS may communicate through access point 10 with the rest of the world.

In the embodiment, the two stations communicating directly with each other may switch the communication channel if a certain event happens. For example, station 13 and station 14 may switch from channel 1 to channel 2 if a predetermined time period expires, or a certain data has not been received from access point 10 for another predetermined time period, or a less-interfered communication is needed, or any combination of the above.

After the two stations switch from an old communication channel (e.g., channel 1) to a new communication channel (e.g., channel 2), they may communicate directly on the new channel. Meanwhile, they may pretend to enter an inactive mode (e.g., power saving mode) in respect to access point 10, so that the communication between either of the two stations and access point 10 may be suspended, which may be depicted in dot line in FIG. 1. In one embodiment, access point 10 may buffer data sent from other stations targeting to either of the two stations.

Then, the two stations may switch from the new communication channel back to the old communication channel if a certain event happens. For example, station 13 and station 14 may switch from channel 2 to channel 1 if a predetermined time period expires, or certain data has not been received via channel 2 for another predetermined time period, or the communication quality on channel 2 is not as good as expected, or any combination of the above. After the two stations switch back to the old communication channel, they may communicate directly with each other on the old channel, meanwhile they may communicate indirectly with other stations through access point 10.

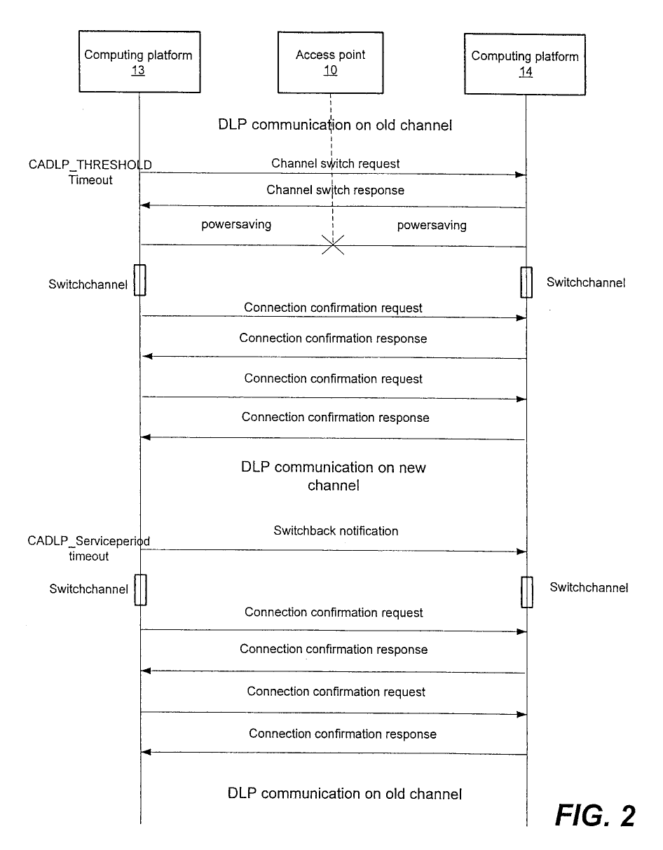

FIG. 2 shows an embodiment of an implementation of communication channel switch between two stations, e.g., station 13 and station 14. The implementation as shown in FIG. 2 can be applied between any two stations within the BSS. Initially, station 13 and station 14 may communicate directly on an old communication channel (e.g., channel 1 of FIG. 1), meanwhile, one or both of them may communicate with other stations inside of or outside of the BSS indirectly on the old communication channel, i.e., passing communication packets through access point 10. Then, station 13 or other device (e.g., station 14) may determine whether an event that may trigger to switch a communication channel happens. As shown in FIG. 2, the event may be whether a predetermined time period expires (e.g., time period CADLP_THRESHOLD).

It should be appreciated that many other events may trigger the switch. In an embodiment, the switch may happen if no or few significant data is received from access point 10 for a while. Here, “significant data” may represent the kind of data important for the communication application, for example, video data may be the significant data for a video communication, while audio data may be the significant data for an audio communication

In another embodiment, the switch may happen if both of the stations agree that a less-interfered communication between them may be needed. This is because the direct communication on the old channel may be easily interfered by other communications on the same channel, for example, the communications between stations 11 and 12, communications between station 13 and access point 10 or communications between station 14 and access point 10.

In response that the event happens, the two stations may check with each other if they can get an agreement on the channel switch. For example, as shown in FIG. 2, one station may send out a channel switch request to check whether another station agrees on the channel switch, and the another station may send a channel switch response to the one station to inform whether it agrees on the switch or not.

If the two stations get an agreement on the channel switch, then both of them may pretend to enter an inactive mode (e.g., power saving model) with respect to access point 10. In an embodiment, either of the two stations may inform access point 10 that it may enter the inactive mode so that communications between the station and access point 10 may be suspended. In the embodiment, access point 10 may buffer communication packets targeting to either of the two stations during the period that the two stations are in the inactive mode.

After getting the agreement on the channel switch, the two stations may switch from the old communication channel (e.g., channel 1) to a new communication channel (e.g., channel 2). The new communication channel may be determined based upon various criteria. In an embodiment, a communication channel with weakest signal strength in respect to one or both of the stations may be selected. In that case, one of the two stations (e.g., station 13) may detect signal strengths on various existing communication channels within the WLAN, e.g., existing communication channels in other BSSes, and may select an existing communication channel having weakest signal strength with respect to the station as the new communication channel. In that way, existing communications on the existing communication channel (e.g., communications in other BSSes) may not severely interfere the communications between the two stations on the new communication channel.

However, it should be appreciated that other criteria may be used to select the new communication channel as long as the communications between the stations on the new communication channel is less-interfered.

After the channel switch, the two stations may confirm the new channel connection with each other, for example, by sending and responding a connection confirmation request as shown in FIG. 2. Then, the two stations may communicate directly on the new communication channel, during which communications between either of them and access point 10 may be suspended. Then, station 13 or other device (e.g., station 14) may determine if an event that may trigger to switch from the new communication channel back to the old communication channel happens. As shown in FIG. 2, the event may be whether a predetermined time period expires (e.g., time period CADLP_Serviceperiod).

It should be appreciated that many other events may trigger the switch. In an embodiment, the switch may happen if no or few significant data is received via the new communication channel for a while. As stated above, “significant data” may represent the kind of data important for the communication application, for example, video data may be the significant data for a video communication, while audio data may be the significant data for an audio communication. In another embodiment, the switch may happen if the communication quality on the new communication channel is not as good as expected.

In response that the event happens, one of the two stations (e.g., station 13) may send a switchback notification to the other station (e.g., station 14), then both of the stations may switch from the new communication channel back to the old communication channel and confirm the old channel connection with each other by sending and responding a connection confirmation request, as shown in FIG. 2.

After the two stations get confirmation on old channel connection, they may communicate directly on the old communication channel; meanwhile, they may pretend to exit the inactive mode with respect to access point 10, so that communications between either of the two stations and access point 10 may be resumed.

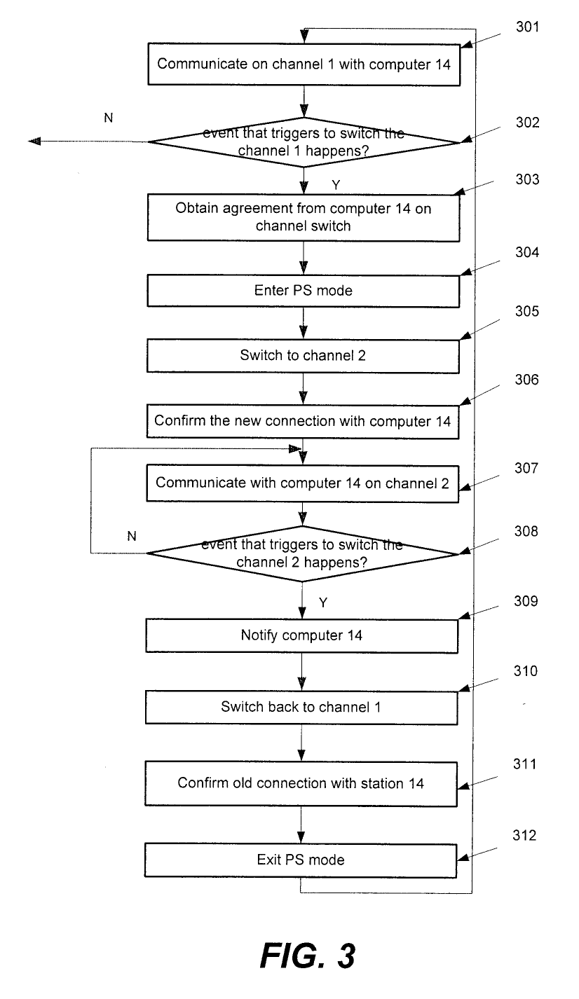

FIG. 3 shows an embodiment of a method of switching a communication channel. In block 301, a station (e.g., station 13) may communicate directly with another station (e.g., station 14) on an old communication channel (e.g., channel 1). Meanwhile, either of stations 13 and 14 may communicate indirectly through access point 10 on the old communication channel. In block 302, station 13 or other device (e.g., station 14) may determine if an event that may trigger to switch from the old communication channel to a new communication channel (e.g., channel 2) happens. In an embodiment, a communication channel having weakest signal strength with respect to one or both of the stations may be selected as the new communication channel. In response that the event happens, station 13 may obtain an agreement from station 14 on channel switch in block 303. In block 304, both of station 13 and 14 may pretend to enter an inactive mode with respect to access point 10.

The two stations may switch from the old communication channel to the new communication channel in block 305, and may confirm the new channel connection with each other in block 306. In block 307, the two stations may communicate directly on the new communication channel, during which communications between either of the two stations and access point 10 may be suspended.

In block 308, station 13 or other device (e.g., station 14) may determine if an event that may trigger to switch from the new communication channel back to the old communication channel happens. In response that the event happens, station 13 may notify station 14 in block 309, so that both of the stations may switch from the new communication channel back to the old communication channel in block 310.

Then, the two stations may confirm the old channel connection with each other in block 311 and may pretend to exit the inactive mode with respect to access point 10, so that communications between either of the two stations and access point 10 may be resumed.

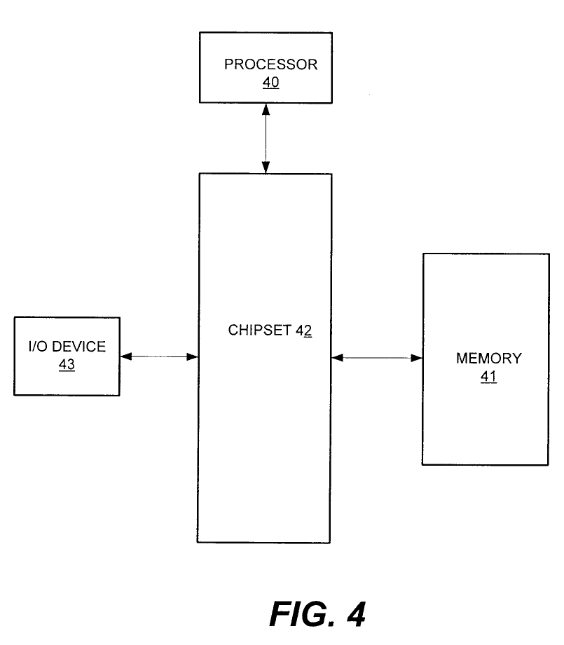

FIG. 4 shows an embodiment of a station. As shown, the station may comprise one or more processor 41, memory system 42, chipset 43, I/O devices 44, and possibly other components. Examples for the station may comprise a cell phone, a digital camera, a computer and other devices for transceiving and processing data.

One or more processors 41 may be communicatively coupled to various components (e.g., the chipset 43) via one or more buses such as a processor bus. Processors 41 may be implemented as an integrated circuit (IC) with one or more processing cores that may execute codes under a suitable architecture, for example, including Intel® Pentium™, Intel® Itanium™, Intel® Core™ Duo architectures, available from Intel Corporation of Santa Clara, Calif.

Memory 42 may store instructions and data to be executed by the processor 41. Examples for memory 42 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

Chipset 43 may provide one or more communicative paths among one or more processors 41, memory 42 and other components, such as I/O devices 44. I/O devices 44 may input or output data to or from computing system 10. Examples for I/O devices 44 may comprise a network card, a blue-tooth, an antenna, and possibly other devices for transceiving data.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method, comprising:
suspending communicating directly with a station on a first communication channel without passing communication packets through an access point;
switching from the first communication channel to the second communication channel;
resuming communicating directly with the station on the second communication channel; and
pretending to be in an inactive mode in respect to the access point when communicating on the second communication channel.

2. The method of claim 1, further comprising suspending communicating indirectly with another station on the first communication channel by passing communication packets through the access point.

3. The method of claim 1, further comprising:
suspending communicating directly with the station on the second communication channel;
switching from the second communication channel back to the first communication channel; and
resuming communicating directly with the station on the first communication channel.

4. The method of claim 3, further comprising pretending to exit the inactive mode with respect to the access point.

5. The method of claim 3, further comprising resuming communicating indirectly with another station on the first communication channel by passing communication packets through the access point.

6. The method of claim 1, further comprising determining to switch from the first communication channel to the second communication channel if a predetermined event happens.

7. The method of claim 6, wherein the predetermined event may be selected from a group comprising whether a predetermined time period expires; whether certain data is not received from the access point through the first communication channel during another predetermined time period; and whether a less-interfered direct communication is needed.

8. The method of claim 1, further comprising determining to switch from the second communication channel back to the first communication channel if a predetermined event happens.

9. The method of claim 8, wherein the predetermined event may be selected from a group comprising whether a predetermined time period expires; whether certain data is not received from the station on the second communication channel during another predetermined time period; and whether communication quality on the second communication channel is not as good as expected.

10. The method of claim 1, further comprising:
monitoring a signal strength on each of a plurality of communication channels; and
selecting a communication channel having weakest signal strength from the plurality of communication channel as the second communication channel.

11. A machine-readable medium comprising a plurality of instructions that in response to being executed result in a system:
suspending communicating directly with a station on a first communication channel without passing communication packets through an access point;
switching from the first communication channel to the second communication channel;
resuming communicating directly with the station on the second communication channel; and
pretending to be in an inactive mode in respect to the access point when communicating on the second communication channel.

12. The machine-readable medium of claim 11, wherein the plurality of instructions further result in the system:
suspending communicating indirectly with another station on the first communication channel by passing communication packets through the access point.

13. The machine-readable medium of claim 11, wherein the plurality of instructions further result in the system:
suspending communicating directly with the station on the second communication channel;
switching from the second communication channel back to the first communication channel; and
resuming communicating directly with the station on the first communication channel.

14. The machine-readable medium of claim 13, wherein the plurality of instructions further result in the system: pretending to exit the inactive mode with respect to the access point.

15. The machine-readable medium of claim 13, wherein the plurality of instructions further result in the system: resuming communicating indirectly with another station on the first communication channel by passing communication packets through the access point.

16. The machine-readable medium of claim 11, wherein the plurality of instructions further result in the system, determining to switch from the first communication channel to the second communication channel if a predetermined event happens.

17. The machine-readable medium of claim 16, wherein the predetermined event may be selected from a group comprising whether a predetermined time period expires; whether certain data is not received from the access point on the first communication channel during another predetermined time period; and whether a less-interfered direct communication is needed.

18. The machine-readable medium of claim 11, wherein the plurality of instructions further result in the system, determining to switch from the second communication channel back to the first communication channel if a predetermined event happens.

19. The machine-readable medium of claim 18, wherein the predetermined event may be selected from a group comprising whether a predetermined time period expires; whether certain data is not received from the station on the second communication channel during another predetermined time period; and whether communication quality on the second communication channel is not as good as expected.

20. The machine-readable medium of claim 11, wherein the plurality of instructions further result in the system:
monitoring a signal strength on each of a plurality of communication channels; and
selecting a communication channel with weakest signal strength from the plurality of communication channel as the second communication channel.
